(19) United States
(12) Patent Application Publication
(10) Pub. No.: US 2025/0356778 A1
(43) Pub. Date: Nov. 20, 2025

(54) TOILET TRAINING APPARATUS

(71) Applicant: Christopher Damien Wilcox, Abbotsford (CA)

(72) Inventor: Christopher Damien Wilcox, Abbotsford (CA)

(21) Appl. No.: 18/665,709

(22) Filed: May 16, 2024

(51) Int. Cl. G09B 19/00; A47K 11/04

(52) U.S. Cl. CPC G09B 19/0076; A47K 11/04

(57) ABSTRACT

A toilet training apparatus that is configured to be releasably secured to the bottom surface of the toilet seat wherein the present invention is configured to dispense urinary target members into the toilet bowl to be utilized as aids in directing urinary streams during toilet training of young boys. The present invention includes a body having a wall defining an interior volume. The body is secured to the bottom surface of the toilet seat. The body has formed therein an aperture providing access to the interior volume. A plurality of urinary target members are disposed within the interior volume of the body. The urinary target members are operable to be released into the toilet bowl during movement of the toilet seat to an up position. The urinary target members are operable to float in the water of the toilet bowl and are manufactured from decomposable materials.

### FIELD OF THE INVENTION

The present invention relates generally to toilet training for young children, more specifically but not by way of limitation, a toilet training device for young boys wherein the device is secured to the bottom surface of the toilet seat and is configured to dispense urinary target members into the toilet bowl.

### BACKGROUND

Millions of parents and caretakers of infants must participate in the routine of toilet training a child as they transition out of diapers. Girls and boys must be trained to utilize the toilet once they reach a certain age. The toilet training process can be challenging for both the trainer and the child. The challenges that the child faces are different based on whether the child is a boy or a girl.

Many young boys struggle with directional control of their urine stream during urination. As young boys are learning to properly urinate into the toilet bowl, many times the young boy will misdirect the urine stream which results in contamination of other areas of the toilet and areas adjacent thereto. While numerous toilet training programs and apparatus exist, there is no training device for toilet training young boys focused on assisting the young boy in directional control of their urine stream during the urination process.

Accordingly, there is a need for a toilet training apparatus to be utilized when toilet training young boys that is operable to assist in the training of the young boy in directional control of their urine stream.

### SUMMARY OF THE INVENTION

It is the object of the present invention to provide a toilet training device operable to assist young boys with directional control of their urine stream wherein the present invention includes a body that is secured to the bottom surface of the toilet seat proximate the front thereof.

Another object of the present invention is to provide a toilet training apparatus that is configured to be releasably secured to a toilet seat wherein the body of the present invention includes an interior volume.

A further object of the present invention is to provide a toilet training device operable to assist young boys with directional control of their urine stream wherein the body includes an aperture in the wall thereof providing access to the interior volume of the body.

Yet a further object of the present invention is to provide a toilet training apparatus that is configured to be releasably secured to a toilet seat wherein the body has disposed in the interior volume thereof a plurality of urinary target members.

Still another object of the present invention is to provide a toilet training device operable to assist young boys with directional control of their urine stream wherein the urinary target members are provided in a plurality of shapes and colors.

An additional object of the present invention is to provide a toilet training apparatus that is configured to be releasably secured to a toilet seat wherein a portion of the urinary target members are released into the toilet bowl during the toilet seat being moved to its up position.

Yet a further object of the present invention is to provide a toilet training device operable to assist young boys with directional control of their urine stream wherein the urinary target members are configured to float in the water of the toilet bowl and are manufactured from a decomposable material.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the present invention secured to an exemplary toilet.

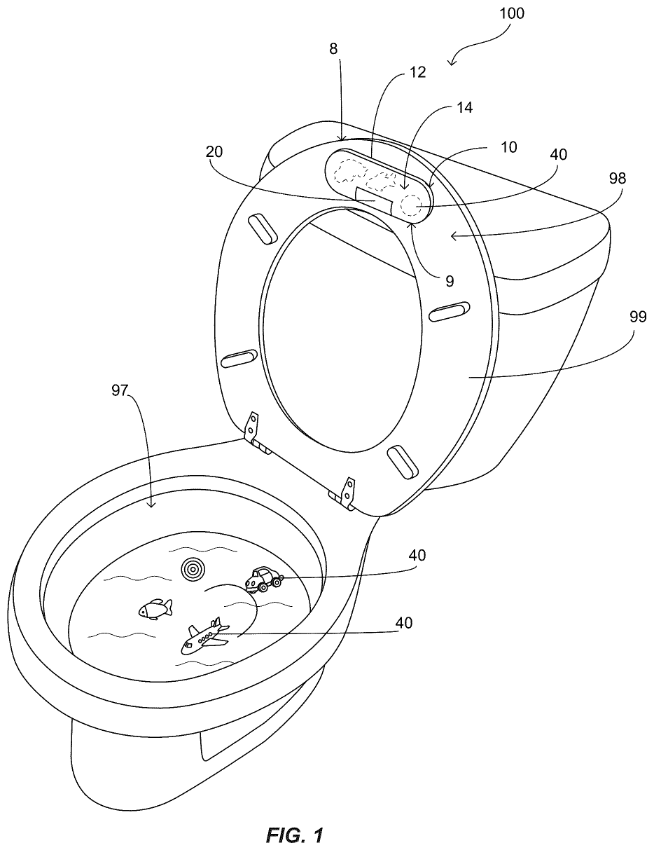

### DETAILED DESCRIPTION

Referring now to the drawings submitted herewith, wherein various elements depicted therein are not necessarily drawn to scale and wherein through the views and FIGURES like elements are referenced with identical reference numerals, there is illustrated a toilet training apparatus 100 constructed according to the principles of the present invention.

An embodiment of the present invention is discussed herein with reference to the FIGURES submitted herewith. Those skilled in the art will understand that the detailed description herein with respect to these FIGURES is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the FIGURES submitted herewith, the toilet training apparatus 100 includes a body 10. The body 10 includes wall member 12 wherein the wall member 12 defines the interior volume 14 of the body 10. The body 10 includes first end 8 and second end 9. The body 10 is releasably secured to the bottom surface 98 of the exemplary toilet seat 99. While the body 10 is illustrated herein as being generally oval in shape, it is contemplated within the scope of the present invention that the body 10 could be provided in alternate shapes and sizes. Furthermore, while a single wall member 12 is employed to form the body 10, it is contemplated within the scope of the present invention that the body 10 could have more than one wall member 12. The body 10 is manufactured having a thickness that does not interfere with operation of the toilet seat 99 permitting the toilet seat 99 to be placed in its conventional down position.

An aperture 20 is formed in the wall member 12 of the body 10. The aperture 20 is formed utilizing suitable techniques and is configured to provide access to the interior volume 14. It is contemplated within the scope of the present invention that the aperture 20 could be formed in alternate sizes and shapes. Furthermore, it is additionally contemplated within the scope of the present invention that the body 10 could have more than one aperture 20 formed therein.

Disposed within the interior volume 14 of the body 10 are a plurality of urinary target members 40. The urinary target members 40 are releasably disposed within the interior volume 14 of the body 10. The urinary target members 40 are manufactured from a suitable decomposable material and are configured to float in the water of the toilet bowl 97. As the toilet seat 99 is moved to its up position, a portion of the urinary target members 40 are released into the toilet bowl 97 exiting via the aperture 20 and depositing into the toilet bowl 97. The urinary target members 40 float in the water and are subsequently utilized by young boys as a target to direct their urinary stream during urination. It should be understood within the scope of the present invention that the urinary target members 40 could be manufactured in various shapes such as but not limited to planes, trains, cars and characters. Furthermore, it is contemplated within the scope of the present invention that the urinary target members 40 could be provided in alternate colors. The urinary target members 40 are flushed ensuing completion of urination by the young boy utilizing the toilet training apparatus 100. While an aperture 20 has been illustrated herein for release of the urinary target members 40, it is contemplated within the scope of the present invention that the urinary target members 40 could be released from the interior volume 14 employing various alternate elements and/or techniques. By way of example but not limitation, a spring-loaded door or similar element could be employed to facilitate the release of the urinary target members 40 during the movement of the toilet seat 99 to its up position.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A toilet training apparatus that is operable to assist a user in direction of a urinary stream during urination wherein the toilet training apparatus comprises:
a body, said body having a first end and a second end, said body having at least one wall member defining an interior volume, said body being releasably secured to a bottom surface of a toilet seat;
at least one aperture, said at least one aperture being formed in said at least one wall member of said body, said at least one aperture providing access to said interior volume of said body;
a plurality of urinary target members, said urinary target members being disposed within said interior volume of said body; and
wherein a portion of the plurality of urinary target members are released from the interior volume when the toilet seat is moved to an up position so as to fall into a bowl of a toilet to which the toilet seat is operably coupled.

2. The toilet training apparatus operable to assist a user in direction of a urinary stream during urination as recited in claim 1, wherein the urinary target members are manufactured from a decomposable material.

3. The toilet training apparatus operable to assist a user in direction of a urinary stream during urination as recited in claim 2, wherein the urinary target members are provided in alternate sizes and shapes.

4. The toilet training apparatus operable to assist a user in direction of a urinary stream during urination as recited in claim 3, wherein the urinary target members are provided in alternate colors.
